(19) United States
(12) Patent Application Publication
(10) Pub. No.: US 2008/0290244 A1
(43) Pub. Date: Nov. 27, 2008

(54) Window Air Filter Apparatus and Method

(76) Inventor: John W. Albright, Fresno, CA (US)

Correspondence Address: PLAGER LAW OFFICES, 16152 BEACG BLVD., SUITE 207, HUNTINGTON BEACH, CA, 92647, US

(21) Appl. No.: 11/754,025

(22) Filed: May 25, 2007

(51) Int. Cl. E06B 3/00

(52) U.S. Cl. 248/544

(57) ABSTRACT

A device and method for holding an air filter comprising a support frame adapted to fit an air filter; one or more anchor tabs operatively engaging the support frame and capable of being secured over a window; and one or more securing members on the support frame for securing the air filter on the support frame. The device may further comprise one or more anchor tabs are flexibly secured to the support frame; fasteners for securing the device over a window; flexibly securing the one or more securing members to the support frame; securing the securing members to the the support frame through one or more fasteners; and using an adhesive or Velcro-type attachment for securing the device over a window.

### BACKGROUND OF THE INVENTION

1. Field of the Invention

The present invention relates to air filters. More particularly, the present invention relates to a device for fitting and retrofitting air filters onto a window or window frame.

2. Description of Related Prior Art

A large problem in homes is that dust from outside easily travels and passes through traditional window screens and settles inside the home. Currently, homes come equipped with a vent system that uses air filters to filter out the dust from ambient air.

Standard air filters typically come in two varieties. The first is that of a disposable, pre-sized filter with a cardboard or other similar, rigid border that can be inserted into an air filter housing. When the filter is dirty, it is then removed, thrown out and replaced with another filter. Air vent housing that receive these filters are of different sizes and so the air filters also come in predetermined sizes based an the different sizes used by home builders.

Other units are reusable filters that come in a single size and are then cut by the homeowner into a size that fits their home air vent housing. The borders on these air filters are typically made of a sturdy but lightweight plastic so that the filters can be washed out with a hose when the filter becomes dust-laden. Although filters, such as those just described, vary in filter density, length, and width, their depths are fairly standard.

There have been attempts at solving this problem through the use of specially adapted window attachments but not without encountering certain difficulties in being able to conform to installed windows which vary greatly in size, length, and width. Further, current adjustable devices are too costly and cumbersome to adapt to the manufacture of window panes. See, for example, U.S. Pat. No. 3,826,182.

Furthermore, current devices are also designed to fit inside the outer window casing which is not always possible with many windows currently available.

Therefore, it is desirable to provide a device for securing a standard air filter and easily fitting it onto a window or window frame for filtering ambient air flowing.

### SUMMARY OF THE INVENTION

Accordingly, it is an object of the present invention to provide a frame device and method for doing the same comprising a support frame adapted to fit and secure an air filter, a fastening mechanism for securing the air filter on the frame, and one or more anchor tabs for securing the frame device to a window frame or window component to cover a window.

It is another object to provide at least one securing member such as a tab or other fastener on the support frame for securing the air filter on the device.

It is another object to provide one or more anchor tabs that are flexibly secured to the support frame.

It is another object to provide one or more anchor tabs secured to the support frame through one or more fastening members.

It is another object to provide at least one securing member that is flexibly secured to the support frame.

It is another object to provide one or more anchor tabs adhered to a window frame or related component with a Velcro-type fastener.

It is another object to provide one or more anchor tab using an adhesive to secure a frame device over a window.

### BRIEF DESCRIPTION OF THE DRAWINGS

FIG. 1 is a perspective rear view of the frame showing all tabs in an extended position.

FIG. 2 is a perspective rear view of the frame showing an air filter secured in the frame with the end tab closed over the end of the filter.

FIG. 3 is a view of the frame and filter secured to a window.

FIG. 4 is a broken out view of a frame side with an S-tab.

### DETAILED DESCRIPTION OF THE DRAWINGS AND PREFERRED EMBODIMENTS

A complete understanding of this invention can be gained through reference to the drawings in conjunction with a thorough review of the disclosure herein.

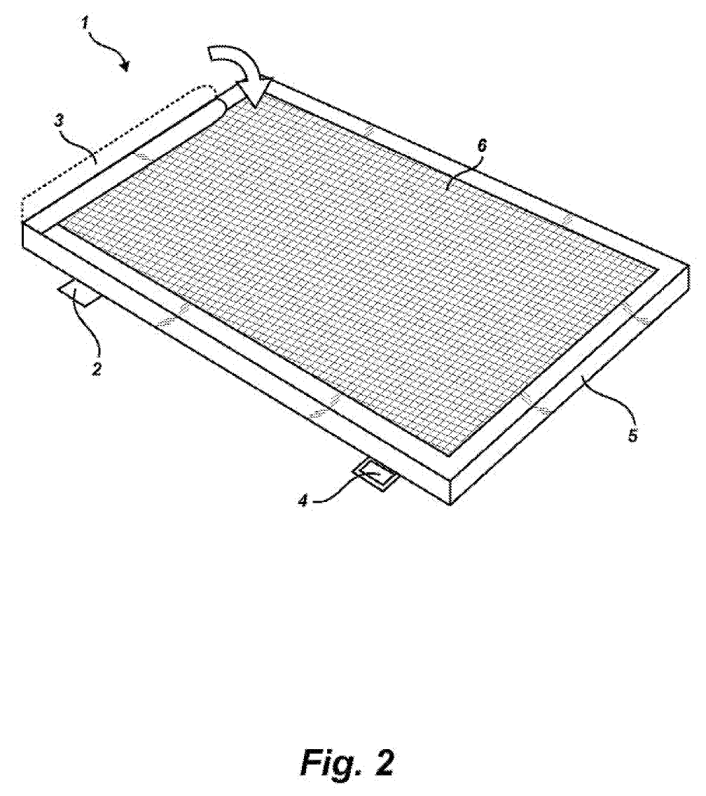

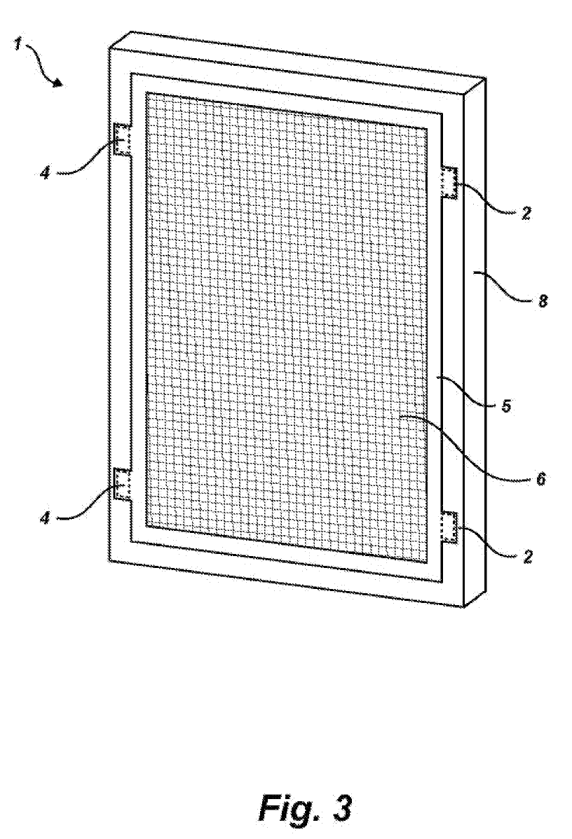

What is disclosed is a novel frame device 1 for receiving and securing a standard air filter over the inside or outside of a window, window screen, or window opening so as to filter out airborne dust and debris from ambient air. This is preferably accomplished by forming a frame 5 from lightweight metal with fastening tabs 2 that attach to a window casing or window frame. Then, an air filter 6 is secured inside device 1 through a holding tab 3. (FIGS. 2 and 3)

In a preferred embodiment a frame 5 is pressed or bended from a single piece of twenty four gauge or similar lightweight metal and portions are cut out of selected regions of the frame 5 to create flexible tabs 2 3 that, once the frame is folded to accommodate a filter 6, can be folded down and used for securing over a window or window screen. A frame 5 is typically formed to fit the shape of standard four-cornered windows which are typically created using standard residential and commercial size requirements. However, window designs vary and so a frame 5 can be adapted or formed to fit the shape of just about any desired window. (E.g., triangles, parallelograms, circular, or oblong)

A preferred embodiment is to form the device 1 from lightweight metal such as 24 gauge sheet metal. Lightweight metal is preferred because it can easily be stamped or cut into the necessary frame 5 elements. However, metal can easily be replaced with plastic, pressed cardboard, or other similarly rigid materials to fit the objects of the present invention.

Frame 5 is created by pressing or otherwise forming a frame structure with four flange sides 6 for holding an air filter in place. Flanges 6 can be also be formed into a “c” channel.

Anchoring tabs 2 used to fasten the device 1 to a window frame are preferred since they are unobtrusive and can be easily adapted to secure to existing window structures.

In the figures, tabs 2 are generally co-planar with the front side (side opposite the filter insertion side) of the frame 5. In another embodiment tabs 2 can also be oppositely adapted to be generally coplanar with the rear plane of the device 1. This embodiment may be preferred for window casings or structures that prevent tabs 2 coplanar with a front plane to be secured to them.

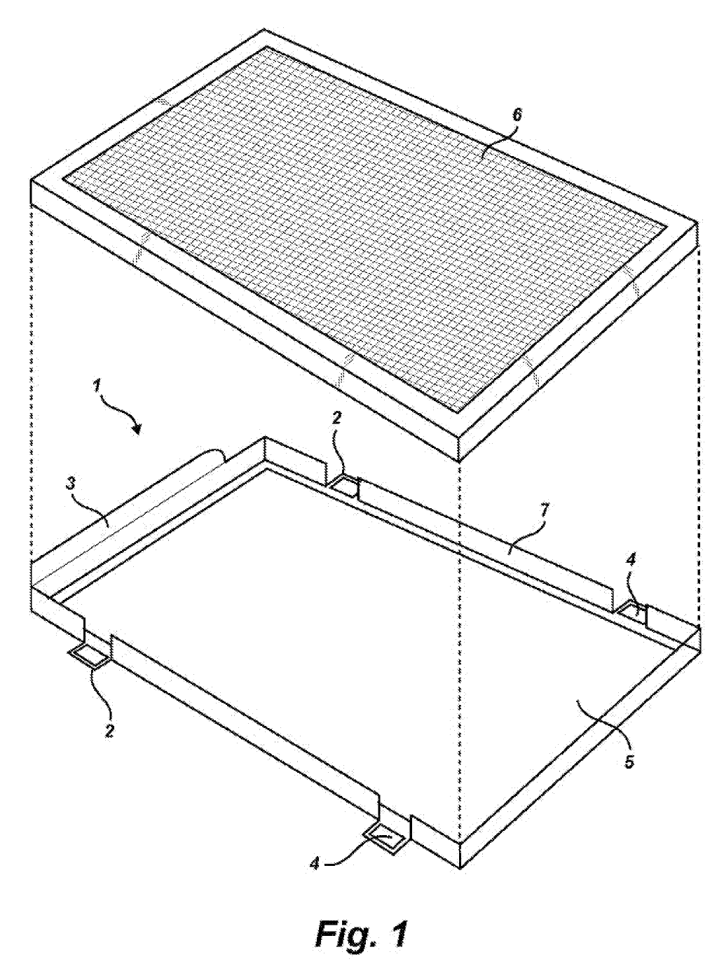

In FIGS. 1-3 there are preferably four tabs of equal size at opposite sides and parallel to each other. This arrangement is preferred since it provides an even distribution of weight of the device 1 and filter 6. However, so long as an adhesive or fastener can support their weight, any number of tabs can be used as can their size and region where they are located.

Tabs 2 are preferably formed from a single stamp or comparable process with pre-defined regions where the tabs 2 are located. The stamping process can define the tab regions, frame side heights and dimensions of another tab 3 or component for securing a filter 6 onto the frame 5. Once a frame 5 is folded into its desired shape, and the filter inserted, tabs 2 can be folded, an adhesive applied to it, and then secured to a desired location over a window.

Other possible ways in which a tab 2 can be adapted to secure a device 1 over a window or screen is by creating perforations (e.g., in the stamping process) to allow for easy folding of the tab 2.

In another embodiment, tabs 2 can be separately secured through known fastening techniques such as through adhesives, rivets, nails, hinges, pivots, or other techniques.

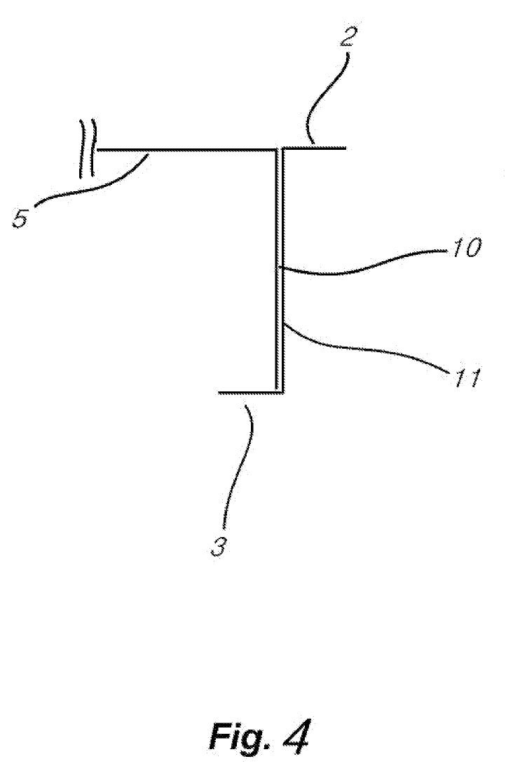

Device 1 is adapted so that the frame 5 and filter 6 are secured by a filter securing tab 3 that is either formed as a foldable tab or as a “c” channel into which a filter 6 can be inserted under. In another exemplary embodiment shown in FIG. 4, an s-tab 11 is spot welded at 10 to form a holding tab 2 and a securing tab 3.

FIG. 1 disclose a preferred device 1 with only a single elongated securing tab 3 that extends almost the whole distance of one end of a frame 5 end. However, a plurality of similar tabs can also be used. Further, other techniques such as hinges, pivots, or separately applied fasteners can also be used.

Device 1 is secured to a window frame 8 or other window component adjacent to a window through the use of tabs 2. To secure the tabs 2 an adhesive 4 or other compound or fastening device is used.

In a preferred embodiment, device 1 is removably secured to a window casing, frame, or other structural component in proximity to the window through an adhesive 4 affixed to tabs 2 either during manufacture, or as a kit component that can be assembled after purchase.

In other embodiments, an adhesive can be replaced with Velcro-type fasteners, tapes, or other similar attachments mechanisms.

Tabs 2 are preferably attached at the exterior of a window frame 9 co-planar with the window frame and the frame 5 of the device 1. However, it is also possible to attach it to the interior of a window in a similar fashion.

The above disclosures do not represent all of the embodiments of the present invention. Those skilled in the art will appreciate many other ancillary embodiments that flow from the novelty of the present invention contained herein.

I claim:

1. A device for holding an air filter comprising:
a support frame adapted to fit an air filter;
one or more anchor tabs operatively engaging the support frame and further comprising means for securing over a window; and
one or more securing members on the support frame for securing the air filter on the support frame.

2. The device of claim 1 wherein: the one or more anchor tabs are flexibly secured to the support frame.

3. The device of claim 1 wherein: the means for securing over a window comprises one or more fasteners.

4. The device of claim 1 wherein: the one or more securing members are flexibly secured to the support frame.

5. The device of claim 1 wherein: said one or more securing members are secured to the support frame through one or more fasteners.

6. The device of claim 1 wherein: the means for securing over a window comprises an adhesive.

7. The device of claim 1 wherein: the means for securing over a window comprises a Velcro-type fastener.

8. A method for securing an air filter over a window structure comprising:
creating a support frame and adapting it to fit over a window structure and adapting it to fit an air filter;
constructing one or more anchor tabs on the support frame and having means for securing over a window;
and
constructing one or more securing members on the support frame for securing the air filter on the device.

9. The method of claim 8 wherein: the one or more anchor tabs are flexibly secured to the support frame.

10. The method of claim 8 wherein: the one or more anchor tabs are secured to the support frame through one or more fasteners.

11. The method of claim 8 wherein: the one or more securing members are flexibly secured to the support frame.

12. The method of claim 8 wherein: the one or more securing members and one or more anchor tabs comprise one or more s-tabs.

13. The method of claim 8 wherein: the means for securing over a window comprises a Velcro-type fastener.

14. The method of claim 8 wherein: the means for securing over a window comprises an adhesive.

15. The device of claim 1 wherein: the one or more securing tabs and the one or more anchor tabs comprise an s-tab.
